(19) United States
(12) Patent Application Publication
(10) Pub. No.: US 2008/0002184 A1
(43) Pub. Date: Jan. 3, 2008

(54) Optical Measurement/Evaluation Method And Optical Measurement/Evaluation Apparatus

(76) Inventors: Yasunori Toda, Hokkaido (JP); Satoru Adachi, Hokkaido (JP)

Correspondence Address: BIRCH STEWART KOLASCH & BIRCH, PO BOX 747, FALLS CHURCH, VA, 22040-0747, US

(21) Appl. No.: 11/667,678

(22) PCT Filed: Nov. 8, 2005
(86) PCT No.: PCT/JP05/20410

§ 371 Date: May 14, 2007

(30) Foreign Application Priority Data
Nov. 15, 2004 (JP) 2004-331123

(51) Int. Cl. G01N 21/00; G01J 3/30

(52) U.S. Cl. 356/73; 356/311

(57) ABSTRACT

A high-sensitivity evaluation technique for optical anisotropy. An optical measurement/evaluation apparatus A has an optical pulse generator 1 which generates optical pulses, half mirror 3, first mirror 5, second mirror 7, third mirror 9, retroreflector 11, wave plate 15, lens 17, spectroscope 21, and controller (PC) 23. An optical pulse L1 emitted from the optical pulse generator 1 is separated into two pulsed lights L2 and L3 by the half mirror 3. The pulsed light L2 is reflected by the mirrors 5 and 7 (pulsed lights L4 and L5) and polarized light of the optical pulse is rotated by the half-wave phase plate 15 installed on a rotary stage 15a and is focused on a surface of a specimen S by the lens 17 (L8). The optical pulse L3 is reflected by the retroreflector 11 which returns light parallel to incident light and non-coaxially (L6), and reflected by the mirror 9. Then polarized light of the optical pulse is rotated by the half-wave phase plate 15 installed on the rotary stage 15a and is focused on the same position on the surface of the specimen S by the lens 17 through an optical path L7 different from L8 above. In so doing, the linearly polarized lights of the two optical pulses are directed at the specimen S by being aligned approximately parallel to each other and being rotated simultaneously. A phenomenon known as four-wave mixing occurs when a wave number k₁ is given to the optical pulse L8 and a wave number k₂ is given to the optical pulse L7. Presence of anisotropic changes due to uniaxial strain or the like in an isotropic thin film causes large anisotropy in the intensity of diffracted light (2k₂−k₁).

### TECHNICAL FIELD

The present invention relates to an optical measurement/evaluation method and optical measurement/evaluation apparatus. More particularly, it relates to a high-sensitivity optical measurement/evaluation technique for thin-film crystals.

### BACKGROUND ART

Reflectance spectroscopy (FIG. 3) and photo-luminescence spectroscopy (FIG. 4) have conventionally been used as simple evaluation methods of optical anisotropy. The reflectance spectroscopy shown in FIG. 3 evaluates a thin film of gallium nitride (GaN) grown on the A-plane sapphire, where the abscissa represents energy and the ordinate represents reflectance. Excitation light emitted from a lamp source illuminates a specimen with a plane of polarization parallel to a crystal axis [-1-120] or [1-100]. Parts where dispersion occurs (indicated by arrows A, B, and C) correspond to exciton levels. In this specimen, differences in thermal expansion coefficient between the A-plane sapphire and GaN thin film are subject to uniaxial strain dependent on the crystal axis. Consequently, changes in a reflection spectrum are observed along with changes in polarization (Non-patent Document 1).

FIG. 4 is a diagram showing an evaluation example of optical anisotropy based on photo-luminescence spectroscopy. The abscissa represents energy and the ordinate represents luminescence intensity. As shown in FIG. 4, several peaks are observed, including impurity levels. Peaks indicated by F correspond to exciton levels and there can be seen optical anisotropy represented by differences between a broken line and solid line (Non-patent Document 2).

Non-patent document 1: “Optical properties of wurtzite GaN epilayers grown on A-plane sapphire”: A. Alemu, B. Gil, M. Julier, and S. Nakamura, Physical Review B57, 3761-3764 (1998)

Non-patent document 2: “Spin-exchange splitting of excitons in GaN”: P. P. Pakov, T. Paskova, P. O. Holtz, and B. Monemar, Physical Review B64, 115201 1-6 (2001)

### DISCLOSURE OF THE INVENTION

Thin-film crystals produced by heteroepitaxial growth are often used for optical devices. A grown thin film is subject to strain or defects due to a difference in thermal expansion coefficient from a substrate or due to lattice mismatch. Such strain causes great changes to electron energy or band structure. By measuring the magnitude and direction of optical anisotropy caused by strain or defects with high sensitivity, it is possible to acquire knowledge needed to obtain expected device performance.

The reflectance spectroscopy and photo-luminescence spectroscopy described in Background Art have been established as optical device evaluation methods, but they are linear with respect to photo-induced polarization, and thus they are not sufficient for microscopic optical anisotropy. That is, since both the techniques concern linear spectroscopy, they tend to have low sensitivity in evaluation of optical anisotropy. Also, to estimate electron energy of a reflection spectrum, they use the Kramers-Kronig transformation which involves a large number of approximation parameters, resulting in low accuracy. On the other hand, photo-luminescence spectroscopy, which inevitably causes spectra superimposition due to impurity levels or the like, has a problem in that it needs comparisons with other techniques in order to identify electron energy.

The present invention has an object to provide a more sensitive evaluation technique for optical anisotropy.

The present invention optically evaluates a thin film by detecting optical anisotropy with high sensitivity using nonlinearity of electron polarization. It estimates optical anisotropy of the thin film from polarization dependence of a spectrum of diffracted light by making use of four-wave mixing spectroscopy which is a type of nonlinear spectroscopy.

By using third-order nonlinearity of electron polarization, the present invention implements optical measurement and evaluation which have sensitivity in the fourth power of conventional linear spectroscopic techniques. This high sensitivity makes it possible to evaluate a strain on the order of MPa (megapascals), for example, on a semiconductor thin film of gallium nitride with high accuracy.

### BRIEF DESCRIPTION OF THE DRAWINGS

FIG. 1A is a diagram showing a simplified configuration example used to theoretically illustrate an optical measurement/evaluation apparatus according to this embodiment;

FIG. 1B is a diagram showing exemplary calculation results obtained by plotting a four-wave mixing spectrum of a thin-film crystal with anisotropy against polarization angle and energy;

FIG. 1C is a diagram showing a more concrete configuration example of the optical measurement/evaluation apparatus according to the first embodiment of the present invention;

FIG. 2 is a diagram showing a principle of a four-wave mixing method;

FIG. 3 is a diagram showing evaluation results of a GaN layer grown on the A-plane sapphire, the evaluation results being produced by an evaluation method of optical anisotropy based on reflectance spectroscopy, where the abscissa represents energy and the ordinate represents reflectance;

FIG. 4 is a diagram showing an evaluation example of optical anisotropy based on photo-luminescence spectroscopy, where the abscissa represents energy and the ordinate represents photo-luminescence intensity;

FIG. 5A is a contour map of peak intensities obtained when polarization of excited optical pulses is rotated by a half-wave phase plate installed on a rotary stage, where the abscissa represents energy and the ordinate represents the angle of polarization;

FIG. 5B is a four-wave mixing spectral diagram obtained when optical pulses with a pulse width of approximately 150 fs are directed at a gallium nitride (GaN) thin film which has uniaxial strain, the spectral diagram showing optical anisotropy of the gallium nitride thin film grown epitaxially on a sapphire substrate, where the abscissa represents energy and the ordinate represents four-wave mixing (FWM) intensity;

FIG. 6 is a group of diagrams in which the diagram at the top left shows polarization dependence of peak intensity when the spectrum in FIG. 5A is approximated by a nonlinear least square method using a Lorentz function, with the abscissa representing polarization and the ordinate representing four-wave mixing intensity, the diagram at the bottom left shows polarization dependence of peak values of energy, with the abscissa representing polarization and the ordinate representing energy, and the diagrams at the right correspond to the diagrams at the left and show oscillator strength, exciton energy, and polarization dependence based on respective response functions;

FIG. 7A is a diagram showing results produced by evaluating a GaN thin film (GaN layer obtained by removing a substrate: 70-μm thick specimen) using the optical measurement/evaluation apparatus according to this embodiment;

FIG. 7B is a diagram showing results produced by evaluating a GaN thin film (GaN layer grown on an isotropic substrate: 2.3-μm thick specimen) using the optical measurement/evaluation apparatus according to this embodiment;

FIG. 8 is a diagram showing a configuration example of an optical measurement/evaluation apparatus according to a second embodiment of the present invention; and

FIG. 9 is a diagram showing a configuration example of a measurement apparatus according to a third embodiment of the present invention.

### DESCRIPTION OF SYMBOLS

A . . . optical measurement/evaluation apparatus, 1 . . . optical pulse generator, 3 . . . half mirror, 5 . . . first mirror, 7 . . . second mirror, 9 . . . third mirror, 11 . . . fourth mirror, 15 . . . wave plate (half-wave phase plate), 17 . . . lens, 21 . . . spectrometer, 23 . . . personal computer (PC) which functions as a control device.

### BEST MODE FOR CARRYING OUT THE INVENTION

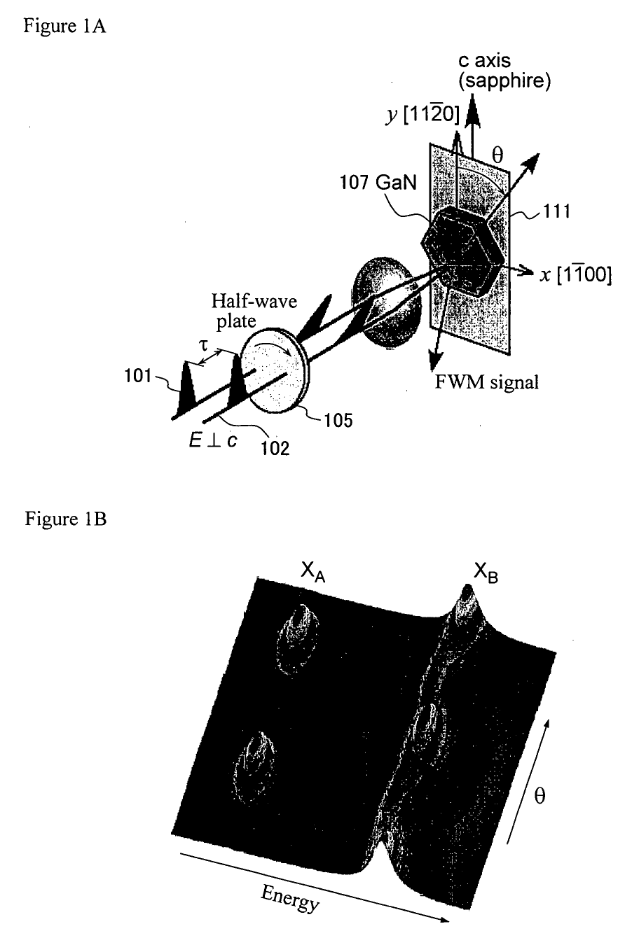

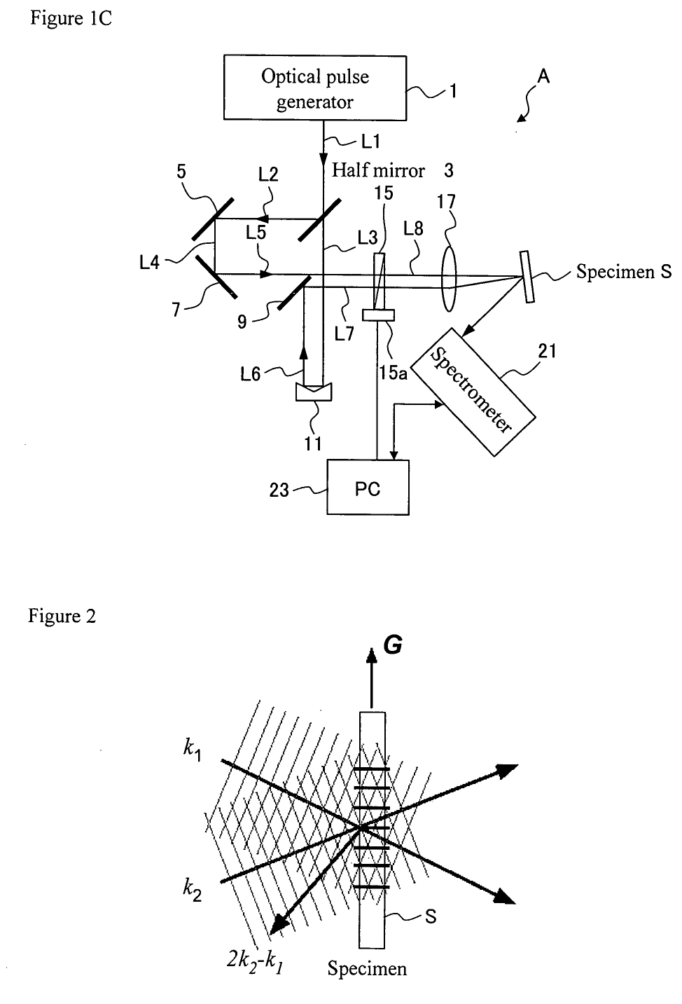

An evaluation technique for optical anisotropy according to embodiments of the present invention will be described below with reference to the drawings. First, description will be given of an evaluation technique for optical anisotropy according to a first embodiment of the present invention. FIG. 1C is a diagram showing a configuration example of an optical measurement/evaluation apparatus according to the first embodiment of the present invention. FIG. 2 is a diagram showing a principle of a four-wave mixing method. As shown in FIG. 2, the four-wave mixing method uses a phenomenon that when two optical pulses with different wave vectors (e.g., k₁ and k₂) enter a thin-film specimen, diffraction grating (wave vector of interference wave: G) of electronic polarization is formed on the specimen S. The method detects diffracted light (2k₂−k₁) as one of the optical pulses is self-diffracted due to the diffraction grating. Four-wave mixing is a known nonlinear spectroscopy, but the evaluation technique for optical anisotropy according to this embodiment is characterized in that it uses four-wave mixing to detect minute changes in optical anisotropy. That is, since intensity of light diffracted by four-wave mixing is proportional to the fourth power of the magnitude (oscillator strength) of electronic polarization, it is believed that anisotropy of a thin-film crystal can be evaluated with high sensitivity. For example, in a thin film which is isotropic toward an inner direction of the specimen, any anisotropic (asymmetric) change due to uniaxial strain or the like causes large anisotropy of diffracted light intensity when polarization of excited optical pulses are rotated.

Also, this technique makes it possible to estimate changes in an electronic band structure caused by anisotropic external field. For example, electron and hole levels in a semiconductor thin film are often spin-degenerate. However, when a anisotropic external field is applied, the spin degeneracy is lifted in such a way as to be expressed by the sum of the spins, resulting in slight energy splitting. The magnitude depends on substance, but it is 1 meV or less at the most. Thus, the use of optical pulses on the order of picoseconds (ps) as an illumination source in the above technique makes it possible to simultaneously excite two levels which are no longer degenerate.

A spin has a momentum which corresponds to circular polarization of light. Thus, the sum of spins can be excited by linearly polarized light. Let us suppose an isotropic semiconductor crystal, spin-up (↑) and spin-down (↓) states of holes in the valence band are degenerate. If a anisotropic external field is applied, quantum state (↑+↓) expressed by the sum of spins differs in energy from (↑−↓). The quantum states (↑+↓) and (↑−↓) have inversely correlated oscillator strengths according to the direction of the external field. Thus, when polarization works in such a way as to enhance the level of one of the quantum states, the level of the other quantum state is suppressed. Peak energies of its diffracted light correspond to level energies.

FIG. 1A is a diagram showing a simplified configuration example used to theoretically illustrate the optical measurement/evaluation apparatus according to this embodiment. It shows four-wave mixing spectra obtained through spectral analysis conducted by passing two pulsed lights 101 and 102 through half-wave plate 105 equipped with a rotary stage while rotating the direction of their polarization with respect to an arbitrary crystal axis of a measuring object (GaN crystal formed on the c-axis oriented A-plane sapphire) 107, where the two pulsed lights 101 and 102, being emitted from a laser (not shown) and arranged into co-linearly polarized lights, have different wave vectors and an arbitrary delay time difference τ (including 0) between themselves. This simplified configuration makes it possible to detect microscopic changes in optical anisotropy unaffected by background influences.

FIG. 1B is a diagram showing exemplary calculation results obtained by plotting a four-wave mixing spectrum of a thin-film crystal with anisotropy against polarization angle and energy. As shown in FIG. 1B, polarity of excitons can be expressed three-dimensionally.

The optical measurement/evaluation apparatus according to the embodiment of the present invention will be described below more concretely.

FIG. 1C is a diagram showing a configuration example of the optical measurement/evaluation apparatus according to the first embodiment of the present invention. As shown in FIG. 1C, the optical measurement/evaluation apparatus A according to this embodiment has an optical pulse generator 1 which generates optical pulses, half mirror 3, first mirror 5, second mirror 7, third mirror 9, fourth mirror 11, wave plate (half-wave phase plate) 15, lens 17, spectrometer 21, and personal computer (PC) 23 which functions as a control device.

With the optical measurement/evaluation apparatus A, an optical pulse L1 emitted from the optical pulse generator 1 is separated into pulsed lights L2 and L3 by the half mirror 3. The pulsed light L2 is reflected by the first mirror 5 and second mirror 7 (pulsed lights L4 and L5) and polarized light of the optical pulse is rotated by the half-wave phase plate 15 installed on a rotary stage 15a and is focused on a surface of the specimen S by the lens 17 (L8). On the other hand, the pulsed light L3 is reflected by the retroreflector 11 which returns light parallel to incident light non-coaxially (L6), and reflected by the mirror 9. Then the polarized light of the optical pulse is rotated by the half-wave phase plate 15 installed on the rotary stage 15a and is focused on the same position on the surface of the specimen S by the lens 17 through an optical path L7 different from L8 above (L7). In so doing, the co-linearly polarized lights of the two optical pulses are directed at the specimen S by being rotated simultaneously.

As shown in FIG. 1C, by designing an optical system in such a way as to separate an optical pulse into two optical pulses and direct them at a specimen along different optical paths, it is possible to give a wave number k₁ to one (L8) of the two optical pulses, and a wave number k₂ to the other (L7). As the specimen S is excited with the two pulses which have the wave number k₁ and wave number k₂, respectively, and are arranged into co-linearly polarized lights, the phenomenon of four-wave mixing shown in FIG. 2 occurs. As described above, since light diffracted by four-wave mixing is proportional to the fourth power of the magnitude (oscillator strength) of electronic polarization, anisotropy of a thin-film crystal can be evaluated with high sensitivity. For example, in an isotropic thin film, any anisotropic change due to uniaxial strain or the like causes large anisotropy in the intensity of diffracted light (2k₂−k₁) when the polarization of excited optical pulses is rotated.

FIGS. 5A and 5B are diagrams showing optical anisotropy of a gallium nitride (GaN) thin film grown epitaxially on a sapphire substrate in an example of an evaluation made by an optical evaluation method according to this embodiment.

FIG. 5A is a contour map of peak intensities obtained when polarization of excited optical pulses is rotated by a half-wave phase plate installed on a rotary stage, where the abscissa represents energy and the ordinate represents an angle θ of linear polarization with respect to an arbitrary crystal orientation. This optical measurement corresponds to a type of crystalline analysis achieved in X-ray diffraction. This technique is safe because it does not involve radioactive material. Also, a small and simplified configuration makes it possible to carry out evaluations and analyses in a portable manner and evaluate crystals in a mounted device. Also, this technique excels in temporal resolution (which is on the order of milliseconds in the case of X-ray diffraction, and on the order of femtoseconds with this technique). This figure shows a spectrum of diffracted light taken in by a spectrometer 21 by rotating the wave plate 15 in increments of 1 degree by means of the rotary stage 15a in the measurement shown in FIG. 1. Height of a contour line represents FWM intensity. The closer to “MAX” shown at top of the figure, the greater the intensity. In FIG. 5A, very distinctive contour patterns are shown as being dependent on energy and rotation angle.

On the other hand, FIG. 5B is a diagram showing a relationship between energy and FWM intensity at rotation angles indicated by arrows, where the abscissa represents energy and the ordinate represents four-wave mixing (FWM) intensity. It shows a four-wave mixing spectra obtained when optical pulses with a pulse width of approximately 150 fs are directed at a gallium nitride (GaN) thin film which has uniaxial strain, with the spectral diagram showing optical anisotropy dependent on the polarization direction of excitation light.

The pattern at the top of FIG. 5B corresponds to crystal axis orientation [-1-120] (where the symbol “-” before numerals is a bar) at a rotation angle θ of π, the pattern in the middle of FIG. 5B corresponds to crystal orientation [−2020] at a rotation angle θ of 0.75 π, and the pattern at the bottom of FIG. 5B corresponds to crystal orientation [1-100] at a rotation angle θ of 0.5 π. In FIG. 5B, a peak of an intensity pattern around an energy of 3.500 eV corresponds to an A exciton peak and a peak of an intensity pattern around an energy of 3.509 eV corresponds to a B exciton peak. It can be seen from FIG. 5B that the A and B exciton peaks differ in polarization dependence.

In FIGS. 5A and 5B, two peaks which correspond to energy levels of the A excitons (electron-hole pairs) and B excitons are observed clearly. The peak intensities correspond to the fourth power of the exciton oscillator strength. The epitaxial thin film of GaN used as a specimen has been grown on the A-plane sapphire substrate. It has different differences in thermal expansion coefficients depending on the crystal axis of the sapphire substrate, and thus it involves uniaxial strain. Also, A and B excitons have mutually different optical anisotropy with respect to strain. Incidentally, the term “peak” here means a spectrum of a certain width.

Thus, it can be seen that the evaluation technique according to this embodiment enables high-sensitivity strain measurement comparable to X-ray analysis using a small, simplified equipment configuration. As advantages over X-ray analysis apparatus, the technique according to this embodiment is capable of mobile analysis among other things and the use of light makes it easy to carry out spatially-resolved measurements and evaluations. Also, the technique is capable of non-destructive inspection, making it possible, for example, to measure crystals processed before or after the start of a production process of an optical device or electronic device. Thus, it is a very practical technique.

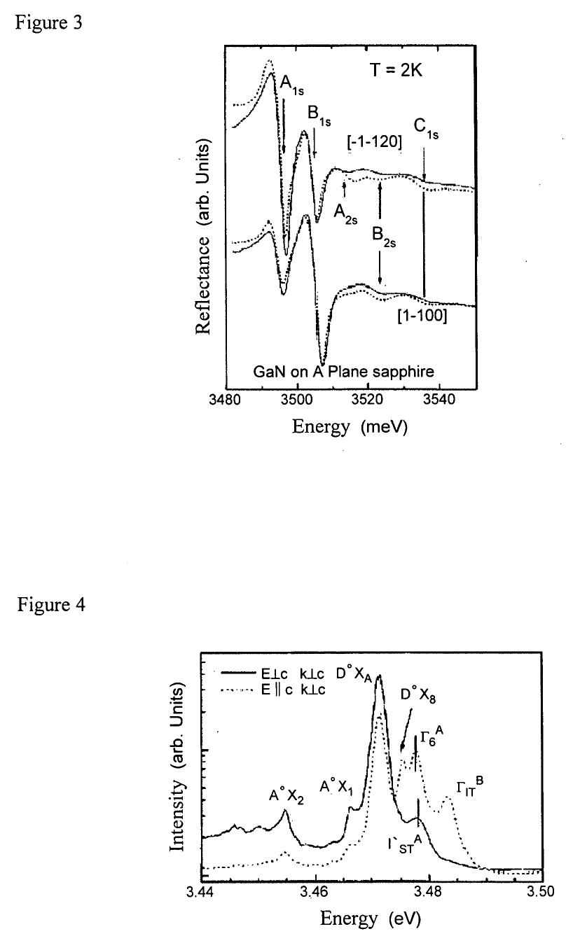

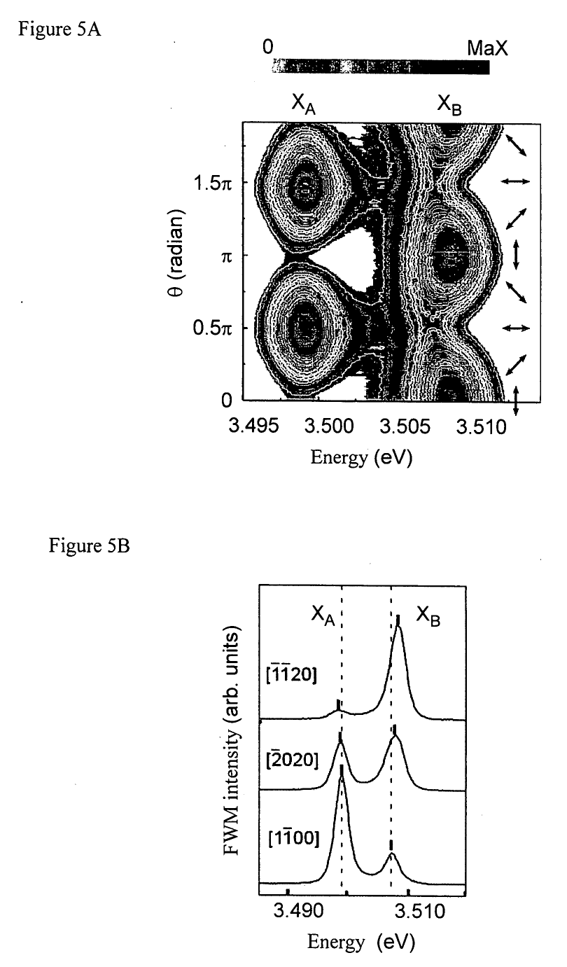

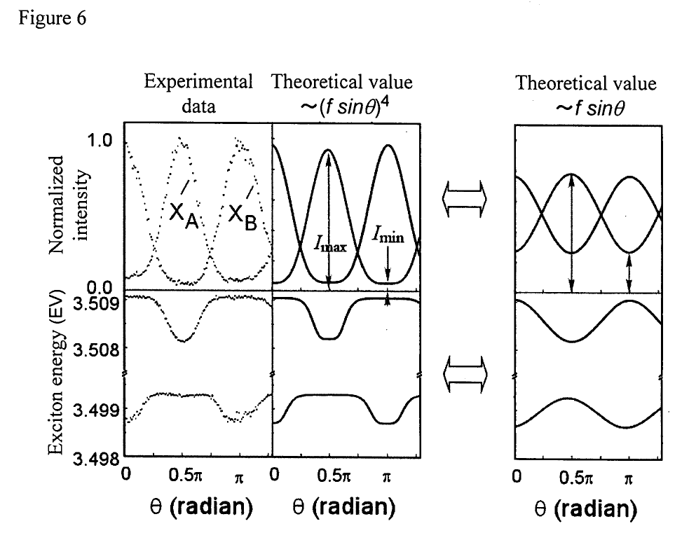

FIG. 6 is a group of diagrams in which the diagram at the top left of FIG. 6 shows polarization dependence of peak intensities corresponding to their respective exciton peaks when the spectra in FIG. 5B are approximated by a nonlinear least square method using a Lorentz function, with the abscissa representing polarization angle and the ordinate representing four-wave mixing diffraction signal intensity. However, the figure compares experimental values with theoretical calculated values after arrival time of the two optical pulses in FIG. 1 to the specimen surface has been adjusted to remove the effect of saturation of exciton intensity due to many-body effects which show up with increases in excitons. Thus, diffracted light intensity corresponds to the fourth power of oscillator strength, and it can be seen that the intensity is far more greater than in the case of the evaluation based on linear spectroscopy (which is proportional to oscillator strength) shown in FIGS. 3 and 4. Furthermore, it has been confirmed that crystal axis orientation on a substrate corresponds to intensity variation caused by polarization. That is, A and B excitons are split into two levels in which spins are added in different ways depending on uniaxial strain. This can be seen from changes in peak energy.

Thus, the experimental value (intensity ratio of Iₘₐₓ/Iₘᵢₙ) of angle θ dependence of intensity and exciton energy approximately coincides with the theoretical value of (fsin θ)⁴ shown in the diagram in the middle of FIG. 6, where f is the oscillator strength. This demonstrates that the observed phenomenon is based on the principle described above.

The diagram at the bottom left of FIG. 6 shows polarization dependence of A and B exciton energy values, where the abscissa represents a polarization angle θ and the ordinate represents exciton energy. A and B excitons are split into two levels which differ in the sum of spins. Changes in the level energy of the excitons are observed depending on the polarization angle. Although split widths of A and B exciton levels are as small as 1 meV or less, polarization dependence which reflects optical anisotropy is observed clearly.

Incidentally, by estimating the split width of exciton energy which has polarization dependence, it is possible to estimate, for example, laser oscillation gain, and thus the split width of exciton energy is an important property value which provides very useful knowledge in designing optical elements.

On the other hand, the diagrams at the right of FIG. 6 show calculated values of fsin θ and correspond to polarization analysis results obtained by linear spectrosccopy based on conventional techniques. It can be seen that the intensity ratios (Iₘₐₓ/Iₘᵢₙ) differ greatly from the experimental values. This technique improves the intensity ratio approximately 10 times over the theoretical calculation results based on conventional techniques. This confirms high sensitivity.

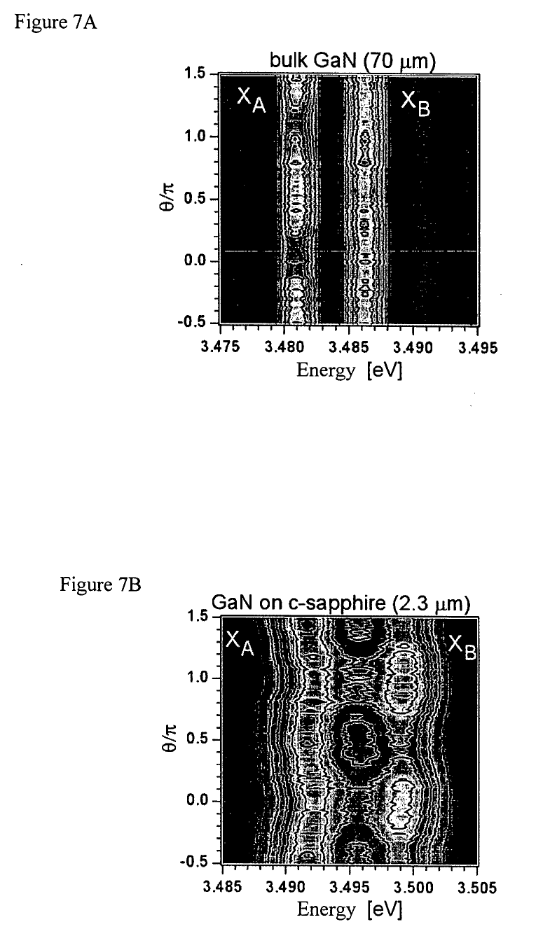

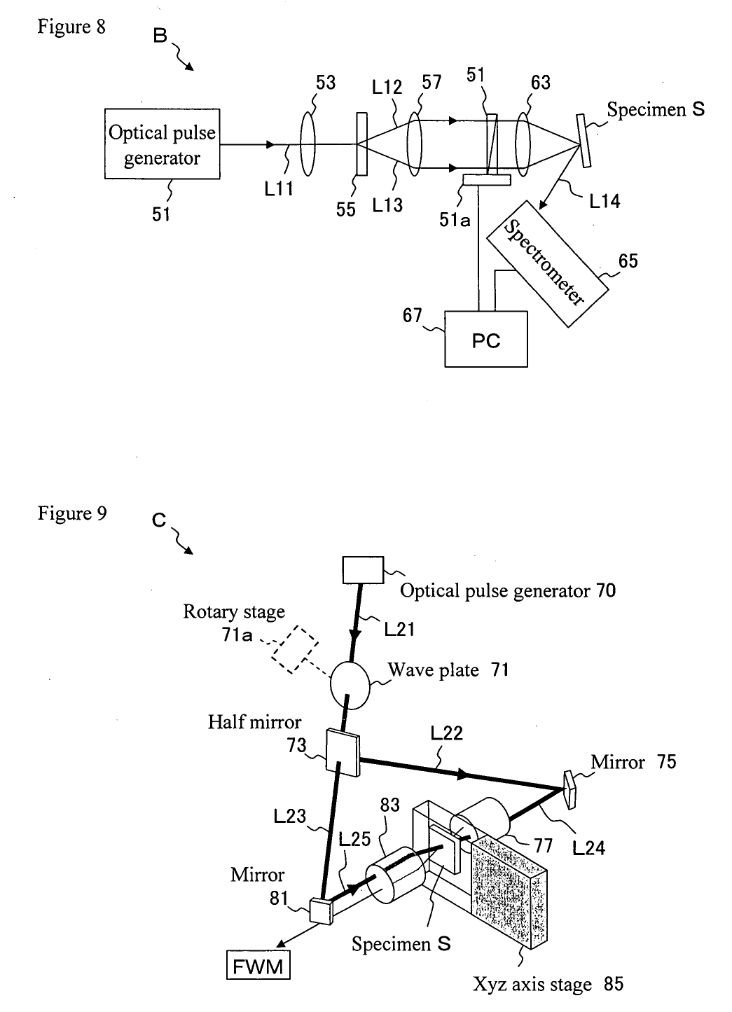

FIGS. 7A and 7B are diagrams showing results produced by evaluating GaN thin films using the optical measurement/evaluation apparatus according to this embodiment, where the GaN thin films (a 70-μm thick specimen, i.e., a GaN layer obtained by removing a substrate in the case of FIG. 8A, and a 2.3-μm thick specimen, i.e., a GaN layer grown on an isotropic substrate in the case of FIG. 8B) can be ideally considered to be generally free of strain. Whereas it is difficult to estimate strain on such a specimen using a conventional technique, the optical measurement/evaluation apparatus according to this embodiment, makes it possible to confirm existence of a periodic light-and-dark pattern for the polarization angle θ as shown in the figures. This demonstrates great improvement in the detection accuracy of strain over conventional techniques. Thus, the optical measurement/evaluation apparatus according to this embodiment, which uses a four-wave mixing method to detect microscopic changes in optical anisotropy, can accurately detect anisotropy inherent in a uniaxial crystal of a thin film which is isotropic toward an inner direction of the specimen, based on the large anisotropy of diffracted light intensity which appears when polarization of excited optical pulses are rotated. Also, it can estimate microscopic energy changes and energy splitting in an electron band structure, which are attributable to spin-exchange interaction caused by an anisotropic external field and are expressed by the sum of spins.

Next, an optical measurement/evaluation technique according to a second embodiment of the present invention will be described with reference to drawings. A measurement system according to this embodiment is characterized by comprising a step of separating an optical pulse into two pulses polarized in the same direction using a diffraction grating unlike the optical measurement/evaluation apparatus shown in FIG. 1C. FIG. 8 is a diagram showing a configuration example of an optical measurement/evaluation apparatus according to this embodiment. As shown in FIG. 8, the optical measurement/evaluation apparatus B according to this embodiment is simplified by the introduction of the step of separating an optical pulse into two pulses using a diffraction grating whereas the optical measurement/evaluation apparatus A shown in FIG. 1C uses an optical delay system to measure temporal changes. That is, as shown in FIG. 7, the optical measurement/evaluation apparatus B according to this embodiment has an optical pulse generator 51 which generates an optical pulse L11, a lens 53 which receives the generated optical pulse L11, a diffraction grating 55 which receives the optical pulse emitted through the lens 53 and separates it into two pulses, a lens 57 which adjusts the two optical pulses L12 and L13 separated by the diffraction grating 55 to be parallel to each other, a half-wave phase plate (wave plate) 51 which, being installed on a rotary stage 51a, rotates the polarized lights of the separated optical pulses L12 and L13, a lens 63 which focuses the optical pulses with wave numbers of k₁ and k₂ on the specimen S, and a spectroscope 65 which spectrally analyzes diffracted light with wave numbers of 2k₁−k₂, produced using four-wave mixing. Incidentally, the rotary stage 51a and spectrometer 65 are controlled by a personal computer (PC) 67 so as to capture peak energy and peak intensity automatically.

The optical measurement/evaluation technique according to this embodiment can accurately evaluate presence of anisotropic changes due to uniaxial strain or the like as in the case of the first embodiment. Furthermore, it can separate an optical pulse into two optical paths of the same light intensity using the diffraction grating and ensure by itself temporal and spatial overlapping of two optical pulses on a specimen. This has the advantage of simplifying the measurement system and eliminating the need to adjust the paths of the optical pulses.

Next, an optical measurement/evaluation technique according to a third embodiment of the present invention will be described with reference to drawings. A measurement apparatus according to this embodiment shown in FIG. 9 is characterized in that it determines spatial anisotropy distribution. To acquire spatial anisotropy distribution, an optical system including spatial movements of a specimen is required. As shown in FIG. 9, an optical measurement/evaluation apparatus C according to this embodiment has an optical pulse generator 70, a wave plate 71, a half mirror 73, a first mirror 75, a second mirror 81, a first objective lens 77, a second objective lens 83, a specimen S, and a xyz axis stage 85. An optical pulse L21 emitted from the optical pulse generator 70 includes the wave plate 71 equipped with a rotary stage 71a, the half mirror 73 which separates an optical pulse polarized and rotated by the wave plate 71 equipped with the rotary stage 71a into an optical pulse L22 and optical pulse L23 by dividing it into two directions, the mirror 75 which reflects the optical pulse L22 so that it will enter the specimen S from one side, the mirror 81 which reflects the optical pulse L23 so that it will enter the specimen S from the other side, the objective lens 77 which focuses an optical pulse L24 reflected by the mirror 75 upon the specimen S, the objective lens 83 which focuses an optical pulse L25 reflected by the mirror 81 upon the specimen S, and the xyz axis stage 85 which can hold and move the specimen S onto x-y-z axes.

Four-wave mixing spectroscopy produces a signal as highly directional diffracted light. This means that it is possible to detect a signal with lower background noise (e.g., Rayleigh scattering of light due to excitation light) than, for example, isotropically emitted light.

However, to obtain a four-wave mixing signal separately from excitation light, it is necessary to focus two excitation lights oriented in different directions in such a way as to make their focal points coincident. The evaluation apparatus according to this embodiment is characterized by emitting excitation lights in opposed directions to obtain a high spatial resolution in a non-coaxial fashion. To obtain a high spatial resolution, optical axes of the two excitation lights are set near the center of an objective lens and their focal points are made coincident. The four-wave mixing signal is detected through an optical axis different from those of the excitation lights owing to a slight difference in direction. This makes it possible to concentrate the excitation lights upon a spatially very small region while separating the excitation lights from the four-wave mixing signal.

In particular, with the above configuration, that location on the specimen on which the optical pulses are focused is varied using the XYZ stage and anisotropy at each point is mapped three-dimensionally by rotating polarization. This makes it possible to estimate anisotropic distribution of external fields. For example, if a thin film has a defect such as threading dislocation, anisotropic strain is induced around the defect and consequently polarization anisotropy is observed. By observing three-dimensional anisotropy, it is also possible to optically evaluate defect distribution.

Since the optical measurement/evaluation methods according to the embodiments of the present invention are nonlinear measurement methods, they heavily depend on power density. Consequently, they are sensitive to focal positions of optical pulses, and allow imaging the inside of a thin film as long as losses from light absorption are acceptable. These technique can evaluate, for example, the effect of a substrate upon strain.

Regarding objects evaluated for optical anisotropy, the above embodiments are applicable to situations in which a anisotropic external field is applied to an isotropic thin-film crystal. Also, although optical anisotropy evaluation techniques for uniaxial strain have been described in the above embodiments by taking as an example a semiconductor thin film of gallium nitride, the present invention is not limited from the viewpoint of characteristics of material or strain or the like. For example, the present invention can measure liquid crystal material and organic semiconductor material as long as the material exhibits a phenomenon which involves excitons. Furthermore, the present invention is applicable to surface analysis of bulk material.

### INDUSTRIAL APPLICABILITY

The present invention is useful as an optical measurement/evaluation apparatus and optical measurement/evaluation method which can accurately evaluate optical anisotropy of thin films indispensable for optical devices and electronic devices.

1. An optical measurement/evaluation apparatus characterized by comprising:
polarization rotating means which rotates linear polarization with respect to an arbitrary crystal axis of a measuring object, where the linear polarization includes a first optical pulse and a second optical pulse whose polarization directions are aligned approximately parallel to each other, the second optical pulse having a different wave vector from the first optical pulse; and
spectroscopic means which spectrally analyzes diffracted light produced through four-wave mixing obtained by directing the first and second optical pulses whose polarization are rotated by the polarization rotating means, at the crystal.

2. An optical measurement/evaluation apparatus characterized by comprising:
optical pulse separating means which separates an optical pulse into two optical pulses, namely a first optical pulse and second optical pulse, the second optical pulse having a different wave vector from the first optical pulse;
polarization rotating means which rotates linear polarization with respect to an arbitrary crystal axis of a measuring object, where the linear polarization includes a first optical pulse and a second optical pulse whose polarization directions are aligned approximately parallel to each other; and
spectroscopic means which spectrally analyzes diffracted light produced through four-wave mixing obtained by directing the first and second optical pulses whose polarization are rotated by the polarization rotating means, at the crystal.

3. The optical measurement/evaluation apparatus according to claim 2, characterized in that the optical pulse separating means includes a diffraction grating installed at a location where the optical pulse is incident.

4. The optical measurement/evaluation apparatus according to any one of claims 1 to 3, characterized by further comprising three-dimensional analyzing means which conducts three-dimensional analysis using energy (wavelength), polarization angle, and diffraction intensity, where the energy is based on an optical spectrum produced by the spectroscopic means and on the polarization angle.

5. An optical measurement/evaluation apparatus characterized by comprising:
polarization rotating means which rotates linear polarization of optical pulses with respect to an arbitrary crystal axis of a measuring object;
spatial separation means which spatially separates the optical pulses whose linear polarization has been rotated; and
spectroscopic means which spectrally analyzes diffracted light produced through four-wave mixing obtained by directing the optical pulses whose linear polarization has been rotated and which have been separated by the spatial separation means, at the crystal from opposed directions.

6. An optical measurement method for detecting optical anisotropy of a crystal characterized by comprising the steps of:
separating an optical pulse into two;
rotating linear polarization of optical pulses whose polarization directions are aligned approximately parallel to each other, with respect to an arbitrary crystal axis of a measuring object; and
spectrally analyzing diffracted light produced through four-wave mixing of the crystal based on the optical pulses whose linear polarization has been rotated.

7. An optical measurement method for detecting optical anisotropy of a crystal characterized by comprising the steps of:
separating an optical pulse into two;
rotating linear polarization of optical pulses whose polarization directions are aligned approximately parallel to each other, with respect to an arbitrary crystal axis of a measuring object; and
detecting third-order nonlinearity of electronic polarization of the crystal based on the optical pulses whose linear polarization has been rotated.

8. The optical measurement/evaluation apparatus according to any one of claims 1 to 3, characterized by comprising three-dimensional analyzing means which conducts three-dimensional analysis based on an optical spectrum obtained by spectrally analyzing diffracted light produced by four-wave mixing and on a polarization angle.
